(19) United States
(12) Patent Application Publication
(10) Pub. No.: US 2026/0111411 A1
(43) Pub. Date: Apr. 23, 2026

(54) ENABLING CHANGE DATA CAPTURE ON HYBRID TABLES

(71) Applicant: Snowflake Inc., Bozeman, MT (US)

(72) Inventors: Amit Chavan, San Jose, CA (US); Cristian Diaconu, Kirkland, WA (US); Chen Luo, San Mateo, CA (US); Joshua Slocum, Austin, TX (US); Daniel E. Sotolongo, Seattle, WA (US); Todd I. Warszawski, Sunnyvale, CA (US)

(21) Appl. No.: 18/920,636

(22) Filed: Oct. 18, 2024

(51) Int. Cl. G06F 16/23; G06F 16/22

(52) U.S. Cl. CPC G06F 16/2358; G06F 16/2282; G06F 16/2379

(57) ABSTRACT

The subject technology dynamically decides between two approaches to produce change data capture (CDC) records depending on estimated cost. One approach corresponds to a time-travel based approach. In the other approach, the subject technology builds off the mutations recorded by the underlying linearizable store between the two timestamps to produce CDC.

### TECHNICAL FIELD

Embodiments of the disclosure relate generally to cloud data platforms and, more specifically, to implementations of Data Manipulation Language (DML) for SQL (Structured Query Language) used to manage and manipulate data within a database system(s), and the like.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

A data platform may store database data (e.g., a table) in multiple storage units, which may be referred to as partitions, micro-partitions, and/or by one or more other names. A database may be organized as records (e.g., rows or a collection of rows) that each include one or more attributes (e.g., columns). In an example, multiple storage units of a database can be stored in a block and multiple blocks can be grouped into a single file. That is, a database can be organized into a set of files where each file includes a set of blocks, where each block includes a set of more granular storage units such as partitions. It should be understood that the terms “row” and “column” are used for illustration purposes and these terms are interchangeable. For example, data arranged in a column of a table can similarly be arranged in a row of the table.

Users and/or executing processes that are associated with a given customer account may, via one or more types of clients, be able to cause data to be ingested into the database, and may also be able to manipulate the data, add additional data, remove data, run queries against the data, generate views of the data, and so forth.

When certain information is to be extracted from a database, a query statement may be executed against the database data. A data platform may process the query and return certain data according to one or more query predicates that indicate what information should be returned by the query. The data platform extracts specific data from the database and formats that data into a readable form.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a data platform, in accordance with some embodiments of the present disclosure.

FIG. 2 is a block diagram illustrating components of a compute service manager of the cloud data platform, in accordance with some embodiments of the present disclosure

FIG. 3 is a flow diagram illustrating operations of a database system in performing a method, in accordance with some embodiments of the present disclosure.

FIG. 4 illustrates an example to compute a set of CDC records between stream offset@ts3 and currentTs@ts7, in accordance with an embodiment of the subject technology.

FIG. 5 is a flow diagram illustrating operations of a database system in performing a method, in accordance with some embodiments of the present disclosure.

FIG. 6 is a flow diagram illustrating operations of a database system in performing a method, in accordance with some embodiments of the present disclosure.

FIG. 7 illustrates an example that determines changes between startTs and endTs, in accordance with an embodiment of the subject technology.

FIG. 8 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In database systems, performing transactions on a given database can be supported. To facilitate that a given transaction is committed to a table, existing database systems can employ varying approaches including Online Transactional Processing (OLTP) techniques. OLTP refers to a category of data processing that involves transaction-oriented tasks. In an example, OLTP involves inserting, updating, and/or deleting varying amounts of data in a given database. OLTP can deal with large numbers of transactions by a large number of users. In some example embodiments, an OLTP database can be implemented as a key-value database in which the data is managed as key-value pairs (e.g., FoundationDB).

Change Data Capture (CDC) is a process that records and makes accessible changes (inserts, updates, deletes) to data in a data source for later consumption.

The efficiency of capturing and emitting these changes depends heavily on the specific properties of the data source and database system.

The subject system supports a table format referred to as a hybrid table, where such a table format includes two key components:
1. An in-memory key-value store for efficient point access
2. A blob format to support efficient scans

The proposed solution aims to provide efficient CDC functionality specifically for these hybrid tables.

To handle a few thousand queries per second (QPS), this volume can present a unique challenge for CDC implementation. Tracking changes from all these queries and allowing a downstream application to consume them for loading into a different table requires a different approach compared to standard (e.g., non-hybrid) tables.

Embodiments of the subject technology provide a CDC implementation strategy for hybrid tables that can efficiently capture and emit changes at high throughput while maintaining the performance benefits of the hybrid table structure. The disclosed techniques can balance a need for real-time change tracking with the efficient point access and scan capabilities of the hybrid table format.

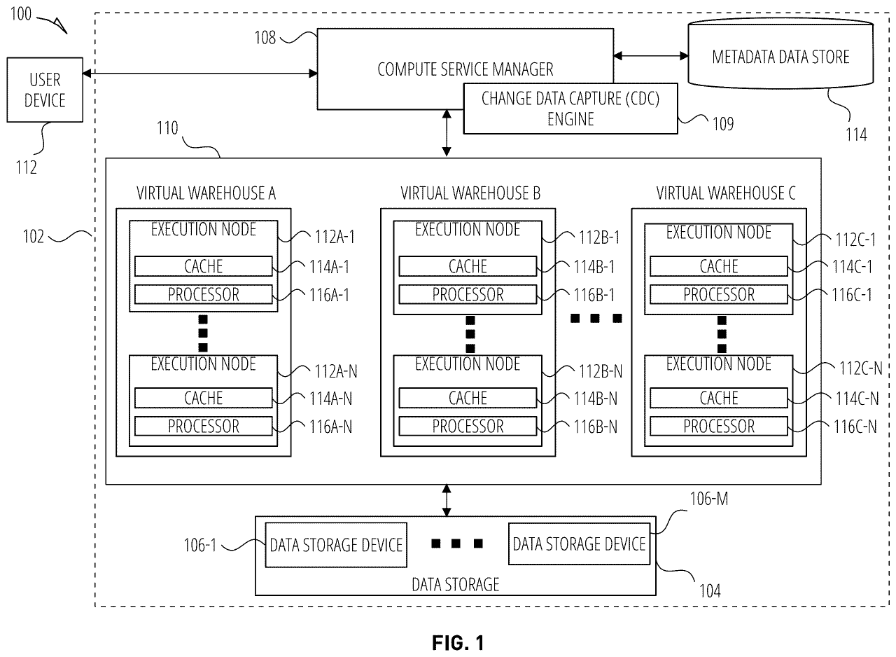

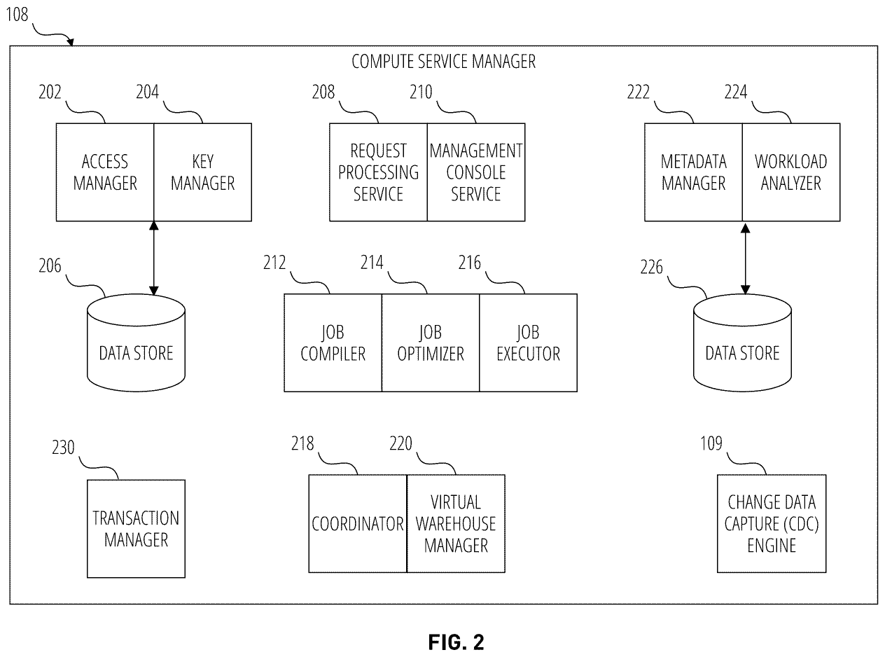

FIG. 1 illustrates an example computing environment 100 that includes a data platform 102, in accordance with some embodiments of the present disclosure. To avoid obscuring the inventive subject matter with unnecessary detail, various functional components that are not germane to conveying an understanding of the inventive subject matter have been omitted from FIG. 2. However, a skilled artisan will readily recognize that various additional functional components may be included as part of the computing environment 100 to facilitate additional functionality that is not specifically described herein.

As shown, the data platform 102 comprises a three-tier architecture: a compute service manager 108 coupled to a metadata data store 114, an execution platform 110, and data storage 104. The data platform 102 hosts and provides data access, management, reporting, and analysis services to multiple client accounts. Administrative users can create and manage identities (e.g., users, roles, and groups) and use permissions to allow or deny access to the identities to resources and services. The data platform 102 is used for reporting and analysis of integrated data from one or more disparate sources including storage devices within the data storage 104. The data storage 104 comprises a plurality of computing machines and provides on-demand computer system resources such as data storage and computing power to the data platform 102.

The compute service manager 108 includes multiple services that coordinate and manage operations of the data platform 102. For example, the compute service manager 108 is responsible for performing query optimization and compilation as well as managing clusters of compute nodes that perform query processing (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also coupled to the metadata data store 114. The metadata data store 114 stores metadata pertaining to various functions and aspects associated with the data platform 102 and its users. The metadata data store 114 also includes a summary of data stored in data storage 104 as well as data available from local caches. Additionally, the metadata data store 114 includes information regarding how data is organized in the data storage 104 and the local caches.

As shown, the compute service manager 108 includes a change data capture engine 109 that is responsible for performing operations related to improving DML queries, including at least generating and maintaining delta files, bitsets, related metadata, and providing CDC for hybrid tables, as discussed further herein. Further details of the operation of the change data capture engine 109 are discussed below.

The compute service manager 108 is also in communication with a user device 112. The user device 112 corresponds to a user of one of the multiple client accounts supported by the data platform 102. In some implementations, the compute service manager 108 does not receive any direct communications from the user device 112 and only receives communications concerning jobs from a queue within the data platform 102.

The compute service manager 108 is also coupled to the metadata data store 114. The metadata data store 114 stores metadata pertaining to various functions and aspects associated with the data platform 102 and its users. The metadata data store 114 also includes a summary of data stored in data storage 104 as well as data available from local caches. Additionally, the metadata data store 114 includes information regarding how data is organized in the data storage 104 and the local caches.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution node 112A-1 to 112A-N; execution node 112A-1 includes a cache 114A-1 and a processor 116A-1; and execution node 112A-N includes a cache 114A-N and a processor 116A-N. Similarly, in this example, virtual warehouse B includes execution node 112B-1 to 112B-N; execution node 112B-1 includes a cache 114B-1 and a processor 116B-1; and execution node 112B-N includes a cache 114B-N and a processor 116B-N. Additionally, virtual warehouse C includes execution node 112C-1 to 112C-N; execution node 112C-1 includes a cache 114C-1 and a processor 116C-1; and execution node 112C-N includes an execution node 112C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 2 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 2 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S3™ storage systems or any other data storage technology. Additionally, the data storage 104 may include distributed file systems (e.g., Hadoop Distributed File Systems (HDFS)), object storage systems, and the like. In some examples, the data storage devices 106-1 to 106-M are managed and provided by a third-party data storage platform (e.g., AWS®, Microsoft Azure Blob Storage®, or Google Cloud Storage®).

Each virtual warehouse can access any of the data storage devices 106-1 to 106-M shown in FIG. 2. Thus, the virtual warehouses are not necessarily assigned to a specific data storage device 106-1 to 106-M and, instead, can access data from any of the data storage devices 106-1 to 106-M within the data storage 104. Similarly, each of the execution nodes shown in FIG. 2 can access data from any of the data storage devices 106-1 to 106-M. In some examples, a particular virtual warehouse or a particular execution node may be temporarily assigned to a specific data storage device, but the virtual warehouse or execution node may later access data from any other data storage device.

In some examples, communication links between elements of the computing environment 100 are implemented via one or more data communication networks.

These data communication networks may utilize any communication protocol and any type of communication medium. In some examples, the data communication networks are a combination of two or more data communication networks (or sub-networks) coupled to one another.

As shown in FIG. 2, the data storage devices 106-1 to 106-M are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata data store 114 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

The compute service manager 108, metadata data store 114, execution platform 110, and data storage 104 are shown in FIG. 2 as individual discrete components. However, each of the compute service manager 108, metadata data store 114, execution platform 110, and data storage 104 may be implemented as a distributed system (e.g., distributed across multiple systems/platforms at multiple geographic locations). Additionally, each of the compute service manager 108, metadata data store 114, execution platform 110, and data storage 104 can be scaled up or down (independently of one another) depending on changes to the requests received and the changing needs of the data platform 102. Thus, in the described embodiments, the data platform 102 is dynamic and supports regular changes to meet the current data processing needs.

As mentioned further herein, terms “file” and “micro-partition” or partition may each refer to a subset of database data and may be used interchangeably in some embodiments. The file metadata includes information about a micro-partition of the table. Further, metadata may be stored for each column of each micro-partition of the table. The metadata pertaining to a column of a micro-partition may be referred to as an expression property (EP) and may include any suitable information about the column, including for example, a minimum and maximum for the data stored in the column, a type of data stored in the column, a subject of the data stored in the column, versioning information for the data stored in the column, file statistics for all micro-partitions in the table, global cumulative expressions for columns of the table, and so forth. Each column of each micro-partition of the table may include one or more expression properties. It should be appreciated that the table may include any number of micro-partitions, and each micro-partition may include any number of columns. The micro-partitions may have the same or different columns and may have different types of columns storing different information. As discussed further herein, the subject technology provides a file system that includes “EP” files (expression property files), where each of the EP files stores a collection of expression properties about corresponding data. As described further herein, each EP file (or the EP files, collectively) can function similar to an indexing structure for micro-partition metadata. Stated another way, each EP file includes a “region” of micro-partitions, and the EP files are the basis for persistence, cache organization and organizing the multi-level structures of a given table's EP metadata. Additionally, in some implementations of the subject technology, a two-level data structure (also referred to as “2-level EP” or a “2-level EP file”) can at least store metadata corresponding to grouping expression properties and micro-partition statistics.

As mentioned above, a table of a database may include many rows and columns of data. One table may include millions of rows of data and may be very large and difficult to store or read. A very large table may be divided into multiple smaller files corresponding to micro-partitions. For example, one table may be divided into six distinct micro-partitions, and each of the six micro-partitions may include a portion of the data in the table. Dividing the table data into multiple micro-partitions helps to organize the data and to find where certain data is located within the table.

In an embodiment, the metadata data store 114 includes EP files (expression property files), where each of the EP files store a collection of expression properties about corresponding data. As mentioned before, EP files provide a similar function to an indexing structure into micro-partition metadata. Metadata may be stored for each column of each micro-partition of a given table.

In an example, a large source table may be (logically) organized as a set of regions in which each region can be further organized into a set of micro-partitions. Additionally, each micro-partition can be stored as a respective file in the subject system in an embodiment. Thus, the term “file” (or “data file”) as mentioned herein can refer to a micro-partition or object for storing data in a storage device or storage platform. In embodiments herein, each file includes data, which can be further compressed (e.g., using an appropriate data compression algorithm or technique) to reduce a respective size of such a file.

In some embodiments, metadata may be generated when changes are made to one or more source table(s) using a data manipulation language (DML), where such changes can be made by way of a DML statement. Examples of modifying data, using a given DML statement, may include updating, changing, merging, inserting, and deleting data into a source table(s), file(s), or micro-partition(s).

As shown in FIG. 2, the computing environment 100 separates the execution platform 110 from the data storage 104. In this arrangement, the processing resources and cache resources in the execution platform 110 operate independently of the data storage devices 106-1 to 106-M in the data storage 104. Thus, the computing resources and cache resources are not restricted to specific data storage devices 106-1 to 106-M. Instead, all computing resources and all cache resources may retrieve data from, and store data to, any of the data storage resources in the data storage 104.

FIG. 2 is a block diagram illustrating components of the compute service manager 108, in accordance with some embodiments of the present disclosure. As shown in FIG. 2, the compute service manager 108 includes an access manager 202 and a key manager 204 coupled to a data store 206 that stores access information. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data store 226. Data store 226 in FIG. 2 represents any data repository or device within the data platform 102. For example, data store 226 may represent caches in execution platform 110, storage devices in data storage 104, the metadata data store 114, or any other storage device or system.

As shown, transaction manager 230 is included in the compute service manager 108. The transaction manager 230 receives a job that may be divided into one or more discrete transactions, e.g., transaction 0, transaction 1, transaction 2, transaction 3, and so forth through transaction (n). In an embodiment, each transaction includes one or more tasks or operations (e.g., read operation, write operation, database statement, user defined function, and the like) to perform. The transaction manager 230 receives the job and determines transactions that may be carried out to execute the job. The transaction manager 230 is configured to determine the one or more discrete transactions, such as transaction 0, transaction 1, transaction 2, transaction 3, and so forth, based on applicable rules and/or parameters, and assigns transactions.

In an embodiment, the subject system provides concurrency control and isolation for executing transactions (e.g., a series of SQL Statements within a SQL Transaction) against linearizable storage (e.g., a linearizable key-value store, NoSQL database, an OLAP database or data warehouse). A transaction as referred to herein includes a group of operations executed atomically. In an example, such transactions may include read and write operations but can also include operations such as increment, decrement, compare-and-swap, and the like. Further, it is appreciated that linearizable storage may include any type of distributed database (e.g., Apache HBase, Foundation DB, and the like).

In an example, the transaction manager 230 utilizes a linearizable storage, provided by data storage 104, for managing and processing transactions as described herein. In an embodiment, the transaction manager 230 implements a read committed model for performing transactions. As referred to herein, a read committed model can refer to a model that ensures that all read operations performed in a given transaction sees a consistent snapshot of the database (e.g., reading a last set of committed values that existed when the read operation commenced), and the transaction itself successfully commits only if no updates that the transaction has made results in write-write conflicts with any concurrent transactions. In addition, transaction manager 230 implements a two-level transaction hierarchy, where a top-level transaction corresponds to a SQL transaction, and a nested transaction corresponds to a SQL statement within the parent SQL transaction. A given nested transaction can perform operations, such as reads and writes, and can perform a rollback and restart execution zero or more times before succeeding. Upon transaction commit, write operations can become visible, and write locks held by each statement can be released. As mentioned before, the subject system provides concurrency control and isolation for executing a series of SQL Statements within a SQL Transaction against a linearizable storage.

The transaction manager 230 is configured to provide a concurrency control mechanism that can be understood as a combination of multi-version concurrency control for read operations (MVCC) and locking for write operations. The subject system provides read committed isolation where each statement may execute against a different snapshot of the database (e.g., data storage 104), with write locks held until transaction commit.

A transaction can encompass one or more statements, with each statement acquiring an immutable database snapshot through its statement read timestamp (readTs). To manage transaction and statement statuses, a transaction status table (TST) is utilized.

To circumvent a transaction time limit (e.g., Foundation DB's (FDB) 5-second transaction limitation), transaction manager 230 performs prepending a stamp to each version, which contains metadata about the transaction or statement.

When a transaction commits, transaction manager 230 atomically marks it as committed in the TST. For other transactions reading a version, a TST lookup is necessary to determine version visibility.

As an optimization measure, a compaction process rewrites committed versions. In this optimized format, the stamp directly contains the commit timestamp (commitTs), eliminating the need for subsequent TST lookups.

Thus, transaction manager 230 can efficiently manage transactions within the constraints of FDB while providing necessary information for version visibility and transaction status tracking.

In addition, as mentioned above, the compute service manager 108 includes a change data capture engine 109 that is responsible for performing operations related to implementing change data capture for queries on hybrid tables, as discussed further herein. Further details regarding the functionality of the change data capture engine 109 are discussed below.

Embodiments of the subject technology provide techniques for enabling Change Data Capture (CDC) on hybrid tables, which combine operational and analytical workloads. As mentioned herein, a hybrid table refers to a type of table that stores data as key-value pairs, optimized for both operational and analytical workloads, and such a hybrid table can be managed by a transaction manager (e.g., transaction manager 230) that provides multi-statement transaction semantics with read-committed isolation. In an implementation, hybrid tables leverage linearizable storage such as Foundation DB (FDB) for data storage, supporting features like time-travel and efficient change tracking.

Hybrid tables are supported on FDB through the following mechanisms in some implementations:
1. Key-value storage: Hybrid tables store data as key-value pairs in FDB, allowing for efficient point accesses. A hybrid table is mapped to a key-range in FDB. Depending on the workload on the table, the table key range is further broken down into disjoint range granules by FDB (e.g., to better handle the traffic, scale horizontally, and the like).
2. Transaction manager: A transaction manager (e.g., transaction manager 230) for hybrid tables is provided. Such a transaction manager provides multi-statement transaction semantics with read-committed isolation level using MVCC (Multi-Version Concurrency Control).
3. Transaction Status Table (TST): The transaction manager uses a TST to keep track of transaction and statement statuses, working around FDB's 5-second transaction limitation.
4. Hybrid storage: To better support HTAP (Hybrid Transactional/Analytical Processing) workloads, FDB implements a hybrid storage system that replicates live KV data into blob storage. This allows for large scans and backup/restore operations.
5. Range granules: The table key space is divided into range granules, containing snapshot files, delta files, and in-memory mutations. This structure supports efficient data management and historical data retention.
6. Versioning: The transaction manager 230 uses timestamps (implemented as FDB versions) to manage transaction visibility and consistency, including readTs, beginTs, and commitTs.

A delta file, as mentioned herein, can be created by DMLs that delete and/or update rows. In an example, a delta file is associated with exactly one data file referred to as its root file, and stores the difference to that root file. A root file can have exactly zero or more delta files, There is an implicit ordering (aka “chain”) to the delta files. A delta file is created by FDB once a key range has accumulated a certain number/size of changes. After a certain point, such a chain of delta files is collapsed into a root file and the process continues. In an example, each delta file covers a range of time, and specifies what changes occurred during the range of time, where each change has a timestamp.

The native Change Data Capture (CDC) approach for hybrid tables in the subject system offers several advantages:
1. Efficiency over custom implementations: without native CDC support, customers would likely implement their own solutions using time-travel and timestamp tracking. However, this approach is inefficient as it often scans more data than necessary, including unchanged data between two timestamps. A native CDC implementation avoids this inefficiency by focusing only on changed data.
2. Low-cost, high-performance CDC: The techniques described herein can incur no additional costs during DML operations on the table. When identifying changes between two timestamps, it only examines the data that has actually changed during that period.
3. Consistent view across table types. The approach provides a consistent view of changes for transactions spanning both standard tables and hybrid tables.

As mentioned herein, to clarify the terminology used in discussing OLTP transactions within the context of hybrid tables, the following definitions are applied:
FDB (Foundation DB) Terminology:
   FDB read version: A logical clock value that represents the point in time at which an FDB transaction acquires its read snapshot. This snapshot includes all writes committed before the read version.
   FDB commit version: A logical clock value that indicates when an FDB transaction is successfully committed.
Transaction Manager Terminology:
   Statement read timestamp (readTs): The specific timestamp at which a statement obtains its read snapshot of the database state.
   Transaction begin timestamp (beginTs): The timestamp marking the initiation of a transaction, specifically when it first updates the Transaction Status Table (TST).
   Transaction commit timestamp (commitTs): The timestamp indicating when a transaction is successfully committed.

The subject system advantageously provides at least the following features:
1. Efficient CDC Computation: by focusing only on changed data between two timestamps, reducing unnecessary data scans.
2. Always-On CDC: providing a consistent and efficient always-on CDC mechanism
3. Transactional Consistency: Helping ensure a consistent view of changes across transactions that span both standard and hybrid tables, leveraging the transaction management system, including the transaction manager 230.

The aforementioned features collectively enhance performance and provide a seamless CDC experience in hybrid table environments.

Embodiments of the subject technology provide CDC streams on hybrid tables in the subject system. In particular, streams are supported with maximum compatibility and efficient CDC computation for always-on streams. Hybrid tables are designed to support both operational and analytical workloads, storing data as key-value pairs.

Two approaches for computing CDC records are provided: 1) time-travel-based and 2) mutation-based, with a hybrid approach proposed for optimal performance. In some implementations, an FDB API, stream scanner, and integration with a stream management system are provided. Moreover, timestamp selection for cross-domain transactions is also discussed.

Streams are constructs that can be established on tables to record all modifications made to a table. Upon creation, a stream captures an initial snapshot of each row in a source table by setting a point in time known as an offset.

Querying a stream retrieves all changes committed to the table from the offset to the current timestamp. The stream updates its offset when utilized in a Data Manipulation Language (DML) operation.

In an implementation, a stream introduces the following metadata columns on top of a table:
METADATA$ACTION: indicates the DML operation (INSERT, DELETE) recorded
METADATA$ISUPDATE: indicates whether the operation was part of an UPDATE statement. An update is treated as a pair of DELETE and INSERT with this column set to true.
METADATA$ROW_ID: Specifies the unique and immutable ID for the row.

To compute all CDC (Change Data Capture) records for writes committed between two timestamps ts1 and ts2 on a target table, change data capture engine 109 identifies and processes all changes (inserts, updates, and deletes) that occurred on the target table within the time interval (ts1, ts2]. Such a computation can be essential for capturing and tracking data modifications in hybrid tables, enabling efficient change data capture functionality.

Time-travel in the context of databases refers to the ability to query and access historical data at a specific point in time, which allows users to view the state of data as it existed at a particular timestamp in the past.

The following discussion relates to a time-travel based approach for supporting CDC streams on hybrid tables.

More specifically for hybrid tables, time-travel functionality is implemented using timestamps. These timestamps are used to create consistent snapshots of the data, allowing users to query the table as it existed at a specific point in time.

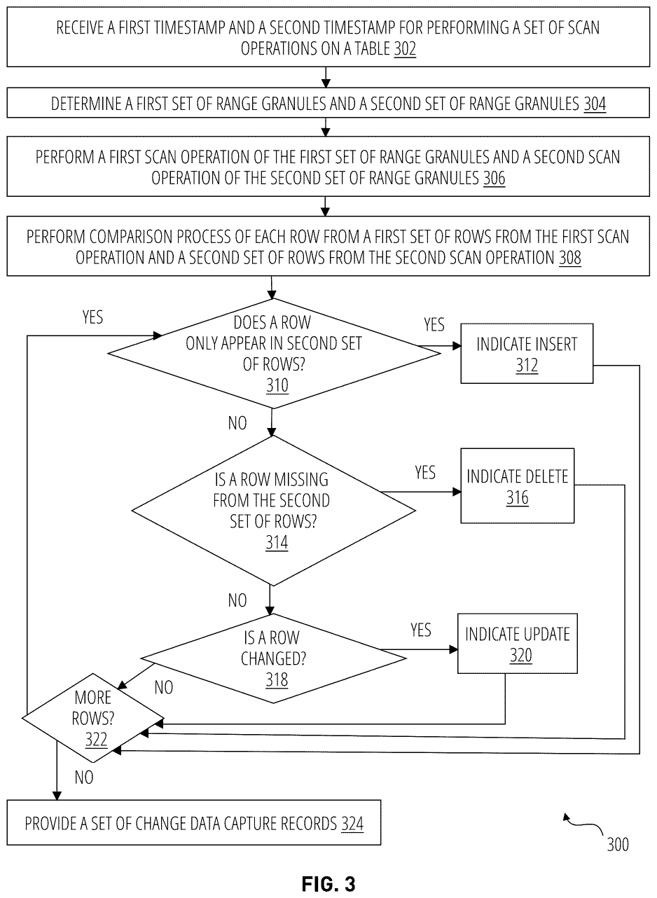

To compute CDC (Change Data Capture) records between two timestamps ts1 and ts2, we can employ a time-travel-based approach that involves scanning the table at both timestamps and comparing the results. This method (further illustrated in FIG. 3) can be described as follows:

Since a given hybrid table is mapped to a key-range in FDB where the table key range can be further broken down into disjoint range granules (e.g., a set of range granules) by FDB, such that instead of scanning the entire key range of the table, the set of range granules can be scanned in parallel. In an implementation, a blob manager is configured to split the key-value data (e.g. OLTP data, Foundation DB data) into the set of range granules, or chunks of data that cover data ranges (e.g., 10 MB chunk for records from A to B, another 10 MB chunk for records from C to F, and so on). Based on the aforementioned, the time-travel approach scans the set of range granules at timestamp ts1 and ts2 to obtain two snapshots of the data.

Compare the rows in both snapshots:
If a row is present in both snapshots with identical values, it is unchanged and can be ignored.
If a row appears only in the ts2 snapshot, it represents an INSERT operation.
If a row is present in the ts1 snapshot but absent from the ts2 snapshot, it indicates a DELETE operation.
If a row exists in both snapshots but with different values, it signifies an UPDATE operation. This is modeled as a combination of a DELETE of the old row and an INSERT of the new row.

This approach provides a comprehensive view of the changes that occurred between the two timestamps, capturing all types of data modifications (inserts, updates, and deletes) in the hybrid table.

In an example, the time-travel-based approach for computing CDC records offers several key advantages:
1. Scalability with table size: the computational cost is proportional to the overall table size rather than the volume of changes. This characteristic makes it particularly effective for calculating CDC records across extended time periods, such as when using the CHANGES clause.
2. Support for table truncates: this approach is uniquely capable of handling table truncate operations, which are metadata-only changes that cannot be captured by mutation-based approaches. For hybrid tables, a truncate operation changes the key-range where the table's data is stored. Every table has an incarnation number (starting with 0) that gets incremented by 1 on a truncate operation. When storing data of a hybrid table, the incarnation number is part of the key-prefix. Thus, changing the incarnation changes the key-prefix, and by extension the key-range.
3. Preservation of old values: this approach inherently captures the original values of deleted rows, providing a comprehensive historical view of data changes.
4. Versatility: due to its ability to handle truncates and preserve old values, this approach serves as a fallback mechanism for scenarios where other approaches may fall short.

These advantages make the time-travel-based approach a robust and versatile solution for computing CDC records, especially in situations involving large-scale data changes or when complete historical data preservation is required.

FIG. 3 is a flow diagram illustrating operations of a database system in performing a method 300, in accordance with some embodiments of the present disclosure. The method 300 may be embodied in computer-readable instructions for execution by one or more hardware components (e.g., one or more processors) such that the operations of the method 300 may be performed by components of data platform 102. Accordingly, the method 300 is described below, by way of example with reference thereto. However, it shall be appreciated that method 300 may be deployed on various other hardware configurations and is not intended to be limited to deployment within the data platform 102.

At operation 302, change data capture engine 109 receives a first timestamp and a second timestamp for performing a set of scan operations on a table.

At operation 304, change data capture engine 109 determines a first set of range granules and a second set of range granules. The first set of range granules corresponding to different data ranges of key-value data (e.g., split in different data chunks) from the table at the first timestamp, and the second set of range granules corresponding to second different data ranges of key-value data (e.g., split in different data chunks) from the table at the second timestamp.

At operation 306, change data capture engine 109 performs a first scan operation of the first set of range granules and a second scan operation of the second set of range granules.

At operation 308, change data capture engine 109 performs a comparison process of each row from a first set of rows from the first scan operation and a second set of rows from the second scan operation.

At operation 310, change data capture engine 109 determines whether a row only appears in the second set of rows. If so, change data capture engine 109 at operation 312 indicates, in response to determining that the row only appears in the second set of rows, an insert operation in a first CDC record corresponding to the row. If not, change data capture engine 109 moves to operation 314.

At operation 314, change data capture engine 109 determines whether a row is missing from the second set of rows. If so, change data capture engine 109 at operation 316 indicates, in response to determining that the row is missing from the second set of rows, a delete operation in a first CDC record corresponding to the row. If not, change data capture engine 109 moves to operation 318.

At operation 318, change data capture engine 109 determines whether a row has changed. If so, change data capture engine 109 indicates at operation 320, in response to determining that the row has changed, an update operation in a first CDC record corresponding to the row. If not, change data capture engine 109 moves to operation 322.

At operation 322, change data capture engine 109 determines whether there are more rows for processing. If there are more rows, change data capture engine 109 moves to operation 310 and performs the operations described above for the remaining row(s). If not, change data capture engine 109 moves to operation 324.

At operation 324, change data capture engine 109 provides a set of change data capture (CDC) records based on the comparison process.

For always-on scenarios with frequent stream refreshes (e.g., every second), a mutation-based approach is proposed to make the cost of computing CDC records proportional to the change size rather than the table size. This approach utilizes a FDB API with additional features to efficiently process changes.

Key aspects of this mutation-based approach include:
1. API Input: This API takes a key range, begin version, and end version as input.
2. API Output: It returns all mutations in the form of delta files and in-memory mutations.
3. Handling Re-snapshotted Range Granules: When a range granule is re-snapshotted, the API ignores the new snapshot and returns old delta files instead. This is crucial because snapshots reconcile sets and clears, which could lead to loss of information about deleted rows.
4. Preserving Deletion Information: By returning old delta files instead of new snapshots, the API ensures that information about deleted rows is not lost, even if a row is deleted and its tombstone is purged within the specified time range (ts1, ts2].

The mutation-based method aims to provide efficient CDC computation for frequently refreshed streams by focusing on the actual changes rather than scanning the entire table, making it more suitable for always-on scenarios in hybrid tables.

The following relates to mapping timestamps to FDB versions.

To map the timestamp range (ts1, ts2] to FDB read versions for querying mutations, the process can be described as follows:
1. End FDB read version: This is straightforwardly set as ts2.
2. Begin read version: To determine this, we need to identify the minimum beginTs of all transactions committed within the interval (ts1, ts2]. This is accomplished by scanning the Transaction Status Table (TST) mutations within the range (ts1, ts2].
3. Committed transaction IDs: The TST scanning process also generates a set of committed transaction IDs, which will be utilized in subsequent steps.
4. Optimization: If the scan reveals that no transactions were committed within the specified range, the subsequent step of mutation processing can be entirely skipped, improving efficiency.

This approach ensures that all relevant mutations are captured while minimizing unnecessary processing, particularly in cases where no changes occurred during the specified time interval.

The following relates to replaying mutations.

The process for fetching and replaying mutations to compute CDC records can be summarized as follows:
1. Fetch all mutations from FDB for the target table within the range [min beginTs, ts2].
2. Merge-sort the delta files, which are already sorted by keys and versions.
3. Process each mutation to compute the CDC record for each key:
   Ignore mutations that do not correspond to committed versions or come from compaction.
   For INSERT mutations, record <KEY, VALUE, INSERT>.
   For DELETE mutations: If the latest recorded mutation is an INSERT, remove it. Otherwise, record <KEY, NULL, DELETE>.
   Handle UPDATE mutations as a combination of DELETE and INSERT.

In an implementation, a stamp format can be provided to differentiate between INSERT and UPDATE operations by introducing a new bit to indicate whether a row is an update or not.

This approach allows for efficient computation of CDC records by focusing on actual changes and handling different types of mutations appropriately. The process takes advantage of the sorted nature of key-value pairs in delta files to streamline the merge-sort operation and subsequent CDC record computation.

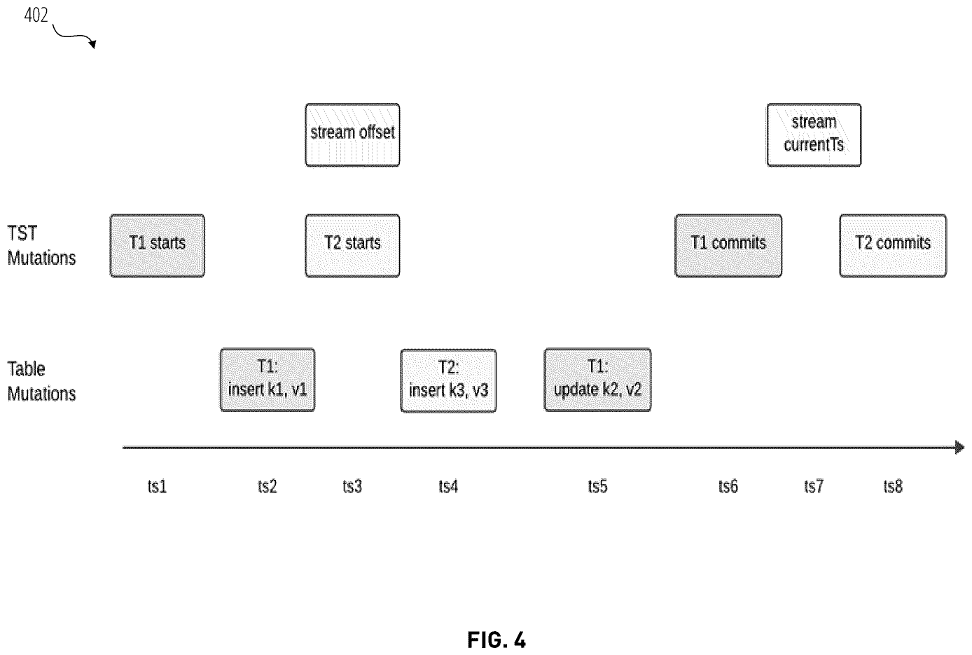

FIG. 4 illustrates an example 402 to compute a set of CDC records between stream offset@ts3 and currentTs@ts7, in accordance with an embodiment of the subject technology. In an implementation, change data capture engine 109 can perform at least some of the operations discussed below.

To illustrate the process of computing CDC records between two timestamps, FIG. 4 shows the following.

In the example of FIG. 4, change data capture engine 109 computes CDC records between stream offset@ts3 (stream offset at timestamp 3) and currentTs@ts7 (current timestamp at timestamp 7). The process involves two main steps:

1) Replay TST (Transaction Status Table) mutations:
Change data capture engine 109 scans TST mutations in the range [ts3, ts7].
This scan reveals that transaction T2 has started and transaction T1 has committed.

2) Replay table mutations:
Starting from the beginTs of T1, change data capture engine 109 replays table mutations in the range (ts1, ts7].

This process produces CDC records that include T1's writes:
<k1, v1, INSERT>
<k2, null, DELETE>
<k2, v2, INSERT>

It's important to note that T2's writes are not included in this refresh. This is because T2 is committed after currentTs (ts7) where currentTs is a current timestamp (e.g., the current time at a particular moment). These changes will be captured and included in the next stream refresh.

This example demonstrates how the mutation-based approach efficiently computes CDC records by focusing only on committed transactions within the specified time range, ensuring that the cost of computation is proportional to the change size rather than the table size.

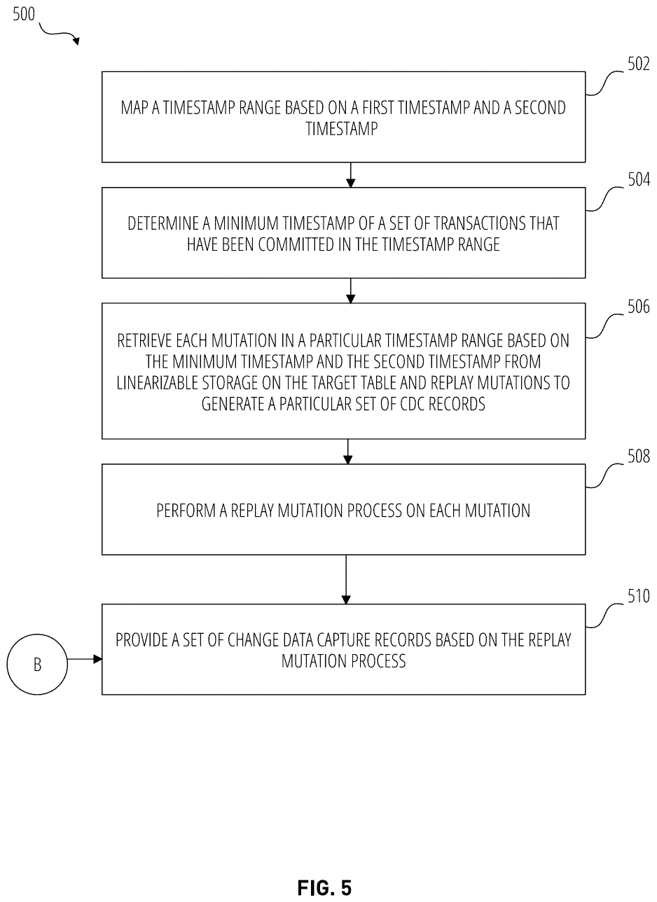

FIG. 5 is a flow diagram illustrating operations of a database system in performing a method 500, in accordance with some embodiments of the present disclosure. The method 500 may be embodied in computer-readable instructions for execution by one or more hardware components (e.g., one or more processors) such that the operations of the method 500 may be performed by components of data platform 102. Accordingly, the method 500 is described below, by way of example with reference thereto. However, it shall be appreciated that method 500 may be deployed on various other hardware configurations and is not intended to be limited to deployment within the data platform 102.

At operation 502, change data capture engine 109 maps a timestamp range based on a first timestamp and a second timestamp.

At operation 504, change data capture engine 109 determines a minimum timestamp of a set of transactions that have been committed in the timestamp range.

At operation 506, change data capture engine 109 retrieves each mutation in a particular timestamp range based on the minimum timestamp and the second timestamp from linearizable storage and replay a set of mutations to generate a particular set of CDC records.

At operation 508, change data capture engine 109 performs a replay mutation process on each mutation.

At operation 510, change data capture engine 109 provides a second set of CDC records based on the replay mutation process.

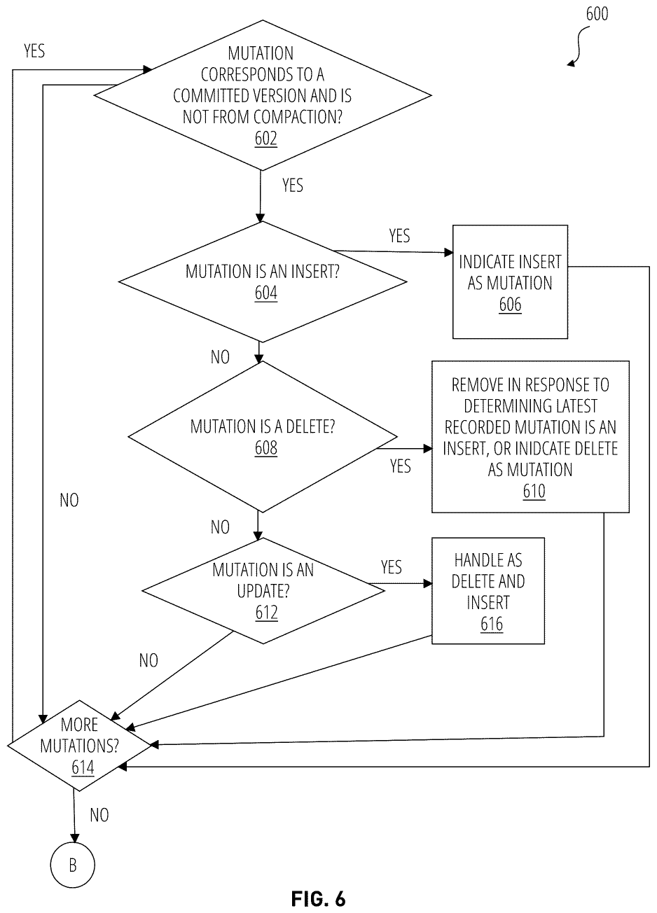

FIG. 6 is a flow diagram illustrating operations of a database system in performing a method 600, in accordance with some embodiments of the present disclosure. The method 600 may be embodied in computer-readable instructions for execution by one or more hardware components (e.g., one or more processors) such that the operations of the method 600 may be performed by components of data platform 102. Accordingly, the method 600 is described below, by way of example with reference thereto. However, it shall be appreciated that method 500 may be deployed on various other hardware configurations and is not intended to be limited to deployment within the data platform 102.

At operation 602, change data capture engine 109 determines whether a mutation corresponds to a committed version and is not from compaction.

At operation 604, change data capture engine 109 determines whether a mutation is an insert operation. If so, at operation 606, change data capture engine 109 indicates, in response to determining that the mutation is the insert operation, the insert operation as the mutation in a first CDC record. If not, change data capture engine 109 moves to operation 608.

At operation 608, change data capture engine 109 determines whether a mutation is a delete operation. If so, at operation 610, change data capture engine 109 removes the mutation in response to determining a latest recorded mutation is an insert, or indicates, in response to determining that the mutation is the delete operation, the delete operation as the mutation in a first CDC record. If not, change data capture engine 109 moves to operation 612.

At operation 612, change data capture engine 109 determines whether a mutation is an update operation. If so, at operation 616, change data capture engine 109 handles the mutation as a delete operation and an insert operation. If not, change data capture engine 109 moves to operation 614.

At operation 614, change data capture engine 109 determines whether there are more mutations. If so, change data capture engine 109 moves back to operation 602 to perform the aforementioned operation(s). If not, change data capture engine 109 continues back to operation 510 in FIG. 5.

The following relates to a hybrid approach.

The hybrid approach for Change Data Capture (CDC) in hybrid tables uses cost-based decisions to dynamically select the most efficient algorithm for each range granule at runtime. Here's a detailed explanation of this approach:
Initial Process: When generating CDC records for a table between timestamps (ts1, ts2\], the system first requests a list of range granules from FDB.
Cost Approximation: For each range granule, the system estimates the CDC computation cost based on FDB blob file sizes:
   Time-travel-based approach: Since hybrid tables store “large” values in a separate key-range, called Out-of-Line Blob (OLB), the cost is the full range granule size (including OLB space) at both ts1 and ts2.
   Mutation-based approach: The cost is the table mutation size from \[beginTs, ts2\]. If old values for DELETEs are required, the full range granule size at beginTs is added.
Cost Estimation Support: A variant of an API is needed to return an approximate total size of mutations without fetching actual data. This could be implemented by allowing the caller to specify a memory limit parameter for fetching memory mutations. Setting this limit to 0 would return only size information.
Accuracy Considerations: The delta files returned by this API may contain data outside the requested key range if the range granule has changed previously. However, using the total size as an approximation remains fairly accurate, assuming such scenarios are rare and I/O costs for processing all blob files are inevitable.
TST Mutation Log Scanning: Estimating the cost of the mutation-based approach requires scanning the Transaction Status Table (TST) mutation logs before processing each range granule. This cost is generally assumed to be small.
Optimization: Even if the time-travel-based approach is chosen later, the TST entries scanned during the estimation phase can be stored in the TST cache to accelerate subsequent CDC computations.
Fallback Mechanism: If the assumption about TST scanning cost doesn't hold for certain workloads, the system can switch to the time-travel-based approach early based on heuristics, such as when the refresh frequency exceeds one day.

This hybrid approach aims to optimize CDC performance by dynamically choosing the most efficient method for each range granule, balancing the trade-offs between the time-travel-based and mutation-based approaches based on the specific characteristics of the data and workload.

The following discussion relates to Timestamp Selection with Cross-Domain Transactions.

A cross-query consistency goal is established for time-travel queries, which is extended to streams and CHANGES operations for hybrid tables. This consistency goal ensures that different types of queries return consistent results for a given table once concurrent operations have settled.

As referred to herein, a “standard” table can refer to a non-hybrid table in which the table is stored or utilizes a different format (e.g., micro-partition, and the like).

Specifically, the consistency goal applies to the following:
1. Time-travel queries:
   select*from standard_table@T
   select*from hybrid_table@T
   select*from standard_table@T full outer join hybrid_table@T
clone hybrid_database@T
1. Stream and CHANGES operations:
   The first execution of select*from stream (created@T with show_initial_rows=true) should return the same results as select*from hybrid_table@T
   select*from hybrid_table changes @T1 and @T2 should be equivalent to computing the difference between select*from hybrid_table @T1 and select*from hybrid_table @T2

Notably, such consistency guarantees are only provided when the query explicitly operates on a past timestamp. This is because concurrent operations are considered “settled” only for past timestamps.

This approach can lead to some subtle and potentially surprising results, particularly in the context of cross-domain transactions. For example:
1. At ts1 (first timestamp): A transaction is prepared
2. At ts2 (second timestamp): A standard table transaction is committed
3. The transaction commit is delayed

In this scenario:
select*from hybrid_table will not see this transaction because the transaction part is not yet committed.
However, select*from hybrid_table @ts2 will see this transaction.

This difference in behavior occurs because the time-travel query at ts2 considers the transaction as settled, while the query without a timestamp only sees the current state where the transaction part is not yet committed.

These consistency guarantees and potential discrepancies between current and time-travel queries are important considerations when implementing and using Change Data Capture (CDC) for hybrid tables, ensuring that users can rely on consistent results when querying historical data across different table types and operations.

The timestamp selection algorithm aims to resolve consistency issues arising from cross-domain transactions that involve both standard tables and hybrid tables. This algorithm is crucial for maintaining a consistent view of data across different table types in hybrid architecture provided by the subject system (e.g., data platform 102).

To illustrate the problem, consider a cross-domain transaction with the following timeline:
1. transaction prepared @T100
2. standard table transaction committed @T110
3. transaction committed @T120

In this scenario, the transaction is effectively committed on the compute service manager 108 side at T110. However, due to potential delays, the commit record is only reflected at T120. Without a proper timestamp selection algorithm, a time-travel query at T115 might inconsistently see the transaction's writes to the standard table but not to the hybrid table.

The timestamp selection algorithm addresses this issue by taking a wall-clock timestamp as input and producing two key outputs:
1. An FDB (FoundationDB) read version
2. A list of transaction IDs considered “committed” at this read version

The algorithm ensures that the selected read version is not greater than any of the selected transactions. This guarantee implies that the components of these transactions will only be committed after the selected read version.

This approach helps maintain consistency across different table types and query operations, including time-travel queries, streams, and CHANGES operations. It ensures that users receive a consistent view of data changes, regardless of whether they are querying standard tables, hybrid tables, or a combination of both.

By implementing this timestamp selection algorithm, the subject system can provide a consistent Change Data Capture (CDC) experience for hybrid tables, even in the presence of complex cross-domain transactions. This consistency is particularly important for scenarios where customers update both standard and hybrid tables within a single transaction, ensuring that any set of begin and end timestamps provides a transactionally consistent view of changes across both table types.

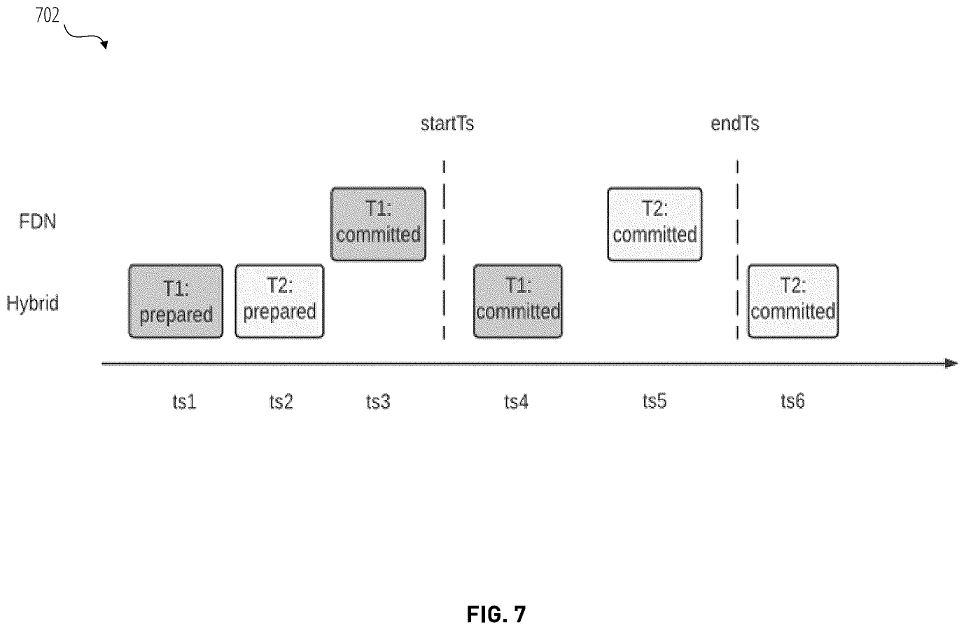

FIG. 7 illustrates an example 702 that determines changes between startTs and endTs, in accordance with an embodiment of the subject technology.

When considering the case where both the start time (startTs) and end time (endTs) are in the past, a goal is to replay all mutations made by transactions committed between (ts1, ts2). However, the timestamp selection algorithm introduces some complexities that need to be addressed to ensure consistency.

The timestamp selection algorithm relies on the compute service manager 108 commit timestamp as the source of truth. This approach reveals two key issues:
1. Exclusion of early commits: Even if a transaction's commit record (like T1) appears after startTs, it may have effectively committed before startTs. In this case, it should be excluded from the result set.
2. Inclusion of late commits: Conversely, a transaction's commit record (like T2) may appear after endTs, but it could have effectively committed before endTs. Such transactions should be included in the result set.

To address these issues, the Change Data Capture (CDC) computation needs to be adjusted to account for the discrepancies between the commit records and the effective commit times as determined by the commit timestamp. This adjustment ensures that the CDC results accurately reflect the state of the data within the specified time range, maintaining consistency with the cross-query consistency goals established for hybrid tables.

The solution involves including transactions that were considered committed within the specified window, even if their commit record was produced after endTs. This approach aligns with the timestamp selection algorithm's goal of providing a consistent view across different table types and query operations, including time-travel queries, streams, and CHANGES operations.

To ensure inclusion of all relevant transactions in the results, the process is extended beyond simply replaying the Transaction Status Table (TST) mutations from [startTs, endTs]. The following additional steps are implemented:
1. Compute Service Manager Involvement: compute service manager 108 is tasked with identifying all cross-domain transactions that were committed within the [startTs, endTs] interval, but whose commit timestamps fall outside this interval for the specific database.
2. Data Transfer: The identified cross-domain transactions are then sent from compute service manager 108 to execution platform 110.
3. Mutation Replay Adjustment: A given execution node (e.g., from execution platform 110) utilizes the beginTs (begin timestamp) of these identified transactions to determine the starting point for replaying data mutations. This ensures that all relevant changes, including those from cross-domain transactions with commit timestamps outside the specified interval, are captured in the Change Data Capture (CDC) results.

This enhanced approach addresses the complexities introduced by the timestamp selection algorithm, particularly in scenarios involving cross-domain transactions. It ensures a more accurate and consistent representation of data changes across both standard tables and hybrid tables, aligning with the cross-query consistency goals established for hybrid tables.

To ensure the exclusion of transactions committed after startTs but prepared before startTs, the following approach is implemented:
1. Additional Storage: The preparedTs (prepared timestamp) is stored in the Transaction Status Table (TST) value.
2. Verification: For transactions committed after startTs but prepared before startTs, compute service manager 108 is consulted to determine their actual commit timestamps. This involves sending the in-doubt transactions to compute service manager 108 for commit status verification.
3. Performance Optimization: To minimize the performance impact of cross-domain transactions, a hasPrepared flag is introduced to the TST value. This flag allows the system to perform the second TST log replay only when cross-domain transactions are actually present.

This approach ensures accurate exclusion of transactions that fall outside the specified time range while optimizing performance by avoiding unnecessary TST log replays when cross-domain transactions are not involved.

When the end time for a Change Data Capture (CDC) operation is set to the current timestamp, the semantics become more complex due to the presence of ongoing, unsettled operations. This complexity arises because concurrent transactions may still be in progress and not yet committed.

In this scenario, the CHANGES clause is designed to provide results equivalent to manually computing the differences between two SELECT statements. To achieve this, the CHANGES clause ignores in-flight committing transactions where commit records have not yet been received.

The implementation follows these key principles:
1. Exclusion of early commits: Transactions committed before the start timestamp (startTs) are excluded from the results.
2. Handling of current transactions: Transactions committed after the end timestamp (endTs, which is current in this case) are not included in the results. This approach aligns with the behavior of SELECT statements operating on the current timestamp, which cannot see in-flight committing transactions.
3. Eventual consistency for stream refreshes: While the CHANGES clause operates on this principle for current-time queries, stream refreshes must ultimately guarantee that all committed transactions are included. This ensures that no data changes are permanently lost or overlooked.

Notably, the use of time-travel semantics for the end timestamp during stream refreshes is less critical in this context. This is because standard table streams face similar challenges with a “quiescing period,” where recent changes may not be immediately visible due to ongoing transactions.

This approach balances the need for consistent, point-in-time views of data changes with the practical limitations of capturing real-time updates in a distributed system with cross-domain transactions. It provides a predictable and manageable way to handle CDC operations that extend to the current timestamp, while ensuring that all committed changes are eventually captured in stream refreshes.

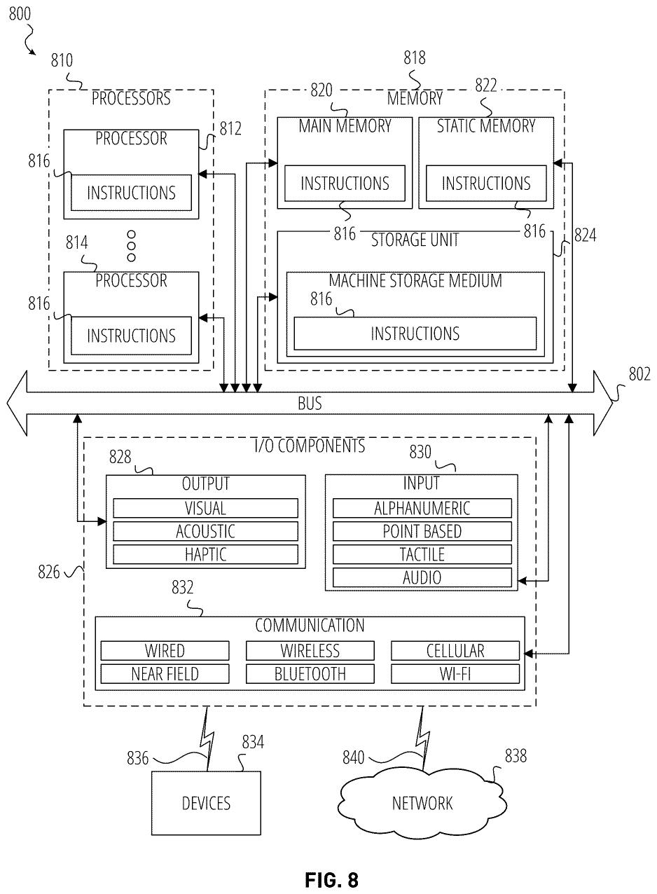

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the 1800 in the example form of a computer system, within which instructions 816 (e.g., a software, a program, an application, an applet, an app, or other executable code) for causing the machine 800 to perform any one or more of the methodologies discussed herein may be executed. For example, the instructions 816 may cause the machine 800 to execute any one or more operations of the method(s) described before. As another example, the instructions 816 may cause the machine 800 to implement any one or more portions of the functionality illustrated in any one of at least some of the figures described herein. In this way, the instructions 816 transform a general, non-programmed machine into a particular machine that is specially configured to carry out any one of the described and illustrated functions of the data platform 102 such as the compute service manager 108 (or a component thereof such as the change data capture engine 109) or an execution node of the execution platform 110.

In some embodiments, the machine 800 operates as a standalone device or may be coupled (e.g., networked) to other machines. In a networked deployment, machine 800 may operate in the capacity of a server machine or a client machine in a server-client network environment or as a peer machine in a peer-to-peer (or distributed) network environment. The machine 800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 includes processors 810, memory 818, and i/o components 826 configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors 810 that may comprise two or more independent processors (sometimes referred to as “cores”) that may execute instructions 816 contemporaneously. Although FIG. 8 shows multiple processors 810, the machine 800 may include a single processor with a single core, a single processor with multiple cores (e.g., a multi-core processor), multiple processors with a single core, multiple processors with multiple cores, or any combination thereof.

The memory 818 may include a main memory 820, a static memory 822, and a storage unit 824, all accessible to the processors 810 such as via the bus 802. The main memory 820, the static memory 822, and the storage unit 824 store the instructions 816 embodying any one or more of the methodologies or functions described herein. The instructions 816 may also reside, completely or partially, within the main memory 820, within the static memory 822, within the storage unit 824, within at least one of the processors 810 (e.g., within the processor's cache memory), or any suitable combination thereof, during execution thereof by the machine 800.

The i/o components 826 include components to receive input, provide output, produce output, transmit information, exchange information, capture measurements, and so on. The specific i/o components 826 that are included in a particular machine 800 will depend on the type of machine. For example, portable machines such as mobile phones will likely include a touch input device or other such input mechanisms, while a headless server machine will likely not include such a touch input device. It will be appreciated that the i/o components 826 may include many other components that are not shown in FIG. 8. The i/o components 826 are grouped according to functionality merely for simplifying the following discussion and the grouping is in no way limiting. In various example embodiments, the i/o components 826 may include output components 828 and input components 830. The output components 828 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components input components 830 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The i/o components 826 may include communication components 832 operable to couple the machine 800 to a network 838 or devices 834 via a coupling 840 and a coupling 836, respectively. For example, the communication components 832 may include a network interface component or another suitable device to interface with the network 838. In further examples, the communication components 832 may include wired communication components, wireless communication components, cellular communication components, and other communication components to provide communication via other modalities. The devices 834 may be another machine or any of a wide variety of peripheral devices (e.g., a peripheral device coupled via a universal serial bus (USB)). For example, as noted above, the machine 800 may correspond to any one of the compute service manager 108, the execution platform 110, and the devices 834 may include the data store 206 or any other computing device described herein as being in communication with the data platform 102 or the data storage 104.

The various memories (e.g., memory 818, main memory 820, static memory 822, and/or memory of the processor(s) processors 810 and/or the storage unit 824) may store one or more sets of instructions 816 and data structures (e.g., software) embodying or utilized by any one or more of the methodologies or functions described herein. These instructions 816, when executed by the processor(s) processors 810, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

In various example embodiments, one or more portions of the network 838 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 838 or a portion of the network 838 may include a wireless or cellular network, and the coupling 840 may be a Code Division Multiple Access (CDMA) connection, a Global System for Mobile communications (GSM) connection, or another type of cellular or wireless coupling. In this example, the coupling 840 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 816 may be transmitted or received over the network 838 using a transmission medium via a network interface device (e.g., a network interface component included in the communication components 832) and utilizing any one of a number of well-known transfer protocols (e.g., hypertext transfer protocol (HTTP)). Similarly, the instructions 816 may be transmitted or received using a transmission medium via the coupling 836 (e.g., a peer-to-peer coupling) to the devices 834. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more. ” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
a memory storing instructions that cause the at least one hardware processor to perform operations comprising:
receiving a first timestamp and a second timestamp for performing a set of scan operations on a table;
determining a first set of range granules and a second set of range granules, the first set of range granules corresponding to the table at the first timestamp, and the second set of range granules corresponding to the table at the second timestamp;
performing a first scan operation of the first set of range granules and a second scan operation of the second set of range granules;
perform a comparison process of each row from a first set of rows from the first scan operation and a second set of rows from the second scan operation; and
providing a set of change data capture (CDC) records based on the comparison process.

2. The system of claim 1, wherein the comparison process comprises:
determining whether a row has changed; and
indicating, in response to determining that the row has changed, an update operation in a first CDC record corresponding to the row.

3. The system of claim 1, wherein the comparison process comprises:
determining whether a row only appears in the second set of rows; and
indicating, in response to determining that the row only appears in the second set of rows, an insert operation in a first CDC record corresponding to the row.

4. The system of claim 1, wherein the comparison process comprises:
determining whether a row is missing from the second set of rows; and
indicating, in response to determining that the row is missing from the second set of rows, a delete operation in a first CDC record corresponding to the row.

5. The system of claim 1, wherein the operations further comprise:
mapping a timestamp range based on a first timestamp and a second timestamp;
determining a minimum timestamp of a set of transactions that have been committed in the timestamp range;
retrieving each mutation in a particular timestamp range based on the minimum timestamp and the second timestamp from linearizable storage and replay a set of mutations to generate a particular set of CDC records;
performing a replay mutation process on each mutation; and
providing a second set of CDC records based on the replay mutation process.

6. The system of claim 5, wherein the replay mutation process comprises:
determining whether a mutation corresponds to a committed version or is not from compaction.

7. The system of claim 5, wherein the replay mutation process comprises:
determining whether a mutation is an insert operation; and
indicating, in response to determining that the mutation is the insert operation, the insert operation as the mutation in a first CDC record.

8. The system of claim 5, wherein the replay mutation process comprises:
determining whether a mutation is a delete operation; and
removing the mutation in response to determining a latest recorded mutation is an insert, or
indicating, in response to determining that the mutation is the delete operation, the delete operation as the mutation in a first CDC record.

9. The system of claim 5, wherein the replay mutation process comprises:
determining whether a mutation is an update operation; and
handling the mutation as a delete operation and an insert operation.

10. The system of claim 6, wherein the operations further comprise:
forgoing processing of the mutation in response to the mutation not corresponding to the committed version or coming from compaction.

11. A method comprising:
receiving a first timestamp and a second timestamp for performing a set of scan operations on a table;
determining a first set of range granules and a second set of range granules, the first set of range granules corresponding to the table at the first timestamp, and the second set of range granules corresponding to the table at the second timestamp;
performing a first scan operation of the first set of range granules and a second scan operation of the second set of range granules;
perform a comparison process of each row from a first set of rows from the first scan operation and a second set of rows from the second scan operation; and
providing a set of change data capture (CDC) records based on the comparison process.

12. The method of claim 11, wherein the comparison process comprises:
determining whether a row has changed; and
indicating, in response to determining that the row has changed, an update operation in a first CDC record corresponding to the row.

13. The method of claim 11, wherein the comparison process comprises:
determining whether a row only appears in the second set of rows; and
indicating, in response to determining that the row only appears in the second set of rows, an insert operation in a first CDC record corresponding to the row.

14. The method of claim 11, wherein the comparison process comprises:
determining whether a row is missing from the second set of rows; and
indicating, in response to determining that the row is missing from the second set of rows, a delete operation in a first CDC record corresponding to the row.

15. The method of claim 11, further comprising:
mapping a timestamp range based on a first timestamp and a second timestamp;
determining a minimum timestamp of a set of transactions that have been committed in the timestamp range;
retrieving each mutation in a particular timestamp range based on the minimum timestamp and the second timestamp from linearizable storage and replay a set of mutations to generate a particular set of CDC records;
performing a replay mutation process on each mutation; and
providing a second set of CDC records based on the replay mutation process.

16. The method of claim 15, wherein the replay mutation process comprises:
determining whether a mutation corresponds to a committed version or is not from compaction.

17. The method of claim 15, wherein the replay mutation process comprises:
determining whether a mutation is an insert operation; and
indicating, in response to determining that the mutation is the insert operation, the insert operation as the mutation in a first CDC record.

18. The method of claim 15, wherein the replay mutation process comprises:
determining whether a mutation is a delete operation; and
removing the mutation in response to determining a latest recorded mutation is an insert, or
indicating, in response to determining that the mutation is the delete operation, the delete operation as the mutation in a first CDC record.

19. The method of claim 15, wherein the replay mutation process comprises:
determining whether a mutation is an update operation; and
handling the mutation as a delete operation and an insert operation.

20. A non-transitory computer-storage medium comprising instructions that, when executed by one or more processors of a machine, configure the machine to perform operations comprising:
receiving a first timestamp and a second timestamp for performing a set of scan operations on a table;
determining a first set of range granules and a second set of range granules, the first set of range granules corresponding to the table at the first timestamp, and the second set of range granules corresponding to the table at the second timestamp;
performing a first scan operation of the first set of range granules and a second scan operation of the second set of range granules;
perform a comparison process of each row from a first set of rows from the first scan operation and a second set of rows from the second scan operation; and
providing a set of change data capture (CDC) records based on the comparison process.
